(19) United States
(12) Patent Application Publication
(10) Pub. No.: US 2020/0356836 A1
(43) Pub. Date: Nov. 12, 2020

(54) FAST DEEP LEARNING FULLY-CONNECTED COLUMN-MAJOR IMPLEMENTATION

(71) Applicant: Apple Inc., Cupertino, CA (US)

(72) Inventors: Asaf HARGIL, Binyamina (IL); Ali SAZEGARI, Cupertino, CA (US)

(21) Appl. No.: 16/568,175

(22) Filed: Sep. 11, 2019

Related U.S. Application Data
(60) Provisional application No. 62/844,723, filed on May 7, 2019.

(51) Int. Cl. G06N 3/04; G06K 9/62; G06F 17/16; G06F 15/80; G06N 3/10

(52) U.S. Cl. CPC G06N 3/04; G06K 9/6267; G06N 3/10; G06F 15/8053; G06F 17/16

(57) ABSTRACT

This application relates to classifying information using a fully-connected layer of a convolutional neural network. A method for classifying information using a fully-connected layer of a convolutional neural network includes calculating a first partial output for a first block of elements by performing a dot product operation using a first row of elements of the first block of elements and a first weight block, where the first row of elements of the first block of elements corresponds to a first batch of elements. The method further includes generating a first output element using the first partial output for the first block of elements and at least one other partial output corresponding to the first batch of elements.

### CROSS-REFERENCE TO RELATED APPLICATIONS

The present application claims the benefit of U.S. Provisional Application No. 62/844,723, entitled “FAST DEEP LEARNING FULLY-CONNECTED COLUMN-MAJOR IMPLEMENTATION,” filed May 7, 2019, the content of which is incorporated herein by reference in its entirety for all purposes.

### FIELD

The described embodiments relate generally to algorithms for data processing. More particularly, the present embodiments relate to algorithms for implementing fast deep learning using a column-major ordered fully-connected layer.

### BACKGROUND

A convolution neural network is a class of deep learning networks that typically includes one or more processors, such as one or more vector processors. Convolutional neural networks include various layers that, using the one or more processors, process inputs (e.g., images or other suitable input) and generate outputs (e.g., class scores, image classifications, or other suitable outputs). For example, the convolution neural network can include convolution layers that process sets of inputs with convolution kernels to generate sets of outputs. Convolutional layers are typically configured to detect high-level features of the inputs, such as edged, curves, simple colors, and the like.

The output of the convolutional layers may be provided by the one or more processors to a fully-connected layer. The fully-connected layer typically connects every “neuron” (e.g., artificial neuron/mathematical function) in one layer of the convolutional neural network to every other neuron in another layer of the convolutional neural network. The fully-connected layer is configured to receive inputs from the convolutional layers and generate outputs that can be used to predict classifications for images associated with the inputs. For example, during training of the convolutional neural network, a plurality of images may be provided to the convolutional neural network (e.g., using the convolutional layers, as described). The convolutional neural network may learn by using the fully-connected layer to classify each of the images.

Typically, the fully-connected layer receives a two-dimensional input matrix (e.g., from the convolutional layers) arranged in row-major order. The fully-connected layer (e.g., using the one or more processors) uses a two-dimensional weight matrix that comprises a plurality of weight values to classify the input. For example, to compute a single output element, one or more processors may perform a dot product operation between a row of the two-dimensional input matrix and a row of the two-dimensional weight matrix. The result of all the dot product operations is a two-dimensional output matrix that comprises a set of values that indicate a probability that an associated input image is an image of a particular object. The accuracy of the output of the fully-connected layer may be determined and the convolutional neural network may receive inputs until the accuracy of the fully-connected layer output is above a threshold.

As described, the two-dimensional input matrix may be arranged in row-major order. Depending on a variety of factors, the two-dimensional weight matrix may be arranged in row-major order or column-major order. Performing dot product operations using a two-dimensional input matrix arranged in row-major order and a two-dimensional weight matrix arranged in column-major order, can be inefficient as the one or more processors performing the dot product operation does not perform consecutive weight matrix memory read operations to retrieve respective input elements and weight values, which may significantly slow training of the convolutional neural network and/or use of the convolutional neural network by other system.

### SUMMARY

Representative embodiments set forth herein disclose techniques for implementing fast deep learning using a column-major ordered fully-connected layer.

An aspect of the disclosed embodiments is a method for classifying information using a fully-connected layer of a convolutional neural network. The method includes, receiving a two-dimensional input matrix that includes a plurality of elements, where each row of the two-dimensional input matrix corresponds to a batch of elements. The method further includes identifying a two-dimensional weight matrix corresponding to the two-dimensional input matrix, the two-dimensional weight matrix including a plurality of weight values. The method further includes identifying a first block of elements of the two-dimensional input matrix. The method further includes loading a first weight block of the two-dimensional weight matrix. The method further includes calculating a first partial output for the first block of elements by performing a first dot product operation using a first row of elements of the first block of elements and the first weight block, where the first row of elements of the first block of elements corresponds to a first batch of elements. The method further includes storing the first partial output. The method further includes generating a first output element using the first partial output for the first block of elements and at least one other partial output corresponding to the first batch of elements.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a two-dimensional input matrix arranged in row-major order and a two-dimensional weight matrix arranged in row-major order, in accordance with some embodiments.

FIG. 2 generally illustrates a two-dimensional input matrix arranged in row-major order and a two-dimensional weight matrix arranged in column-major order, in accordance with some embodiments.

FIG. 3 generally illustrates a multi-layer convolution operation for filtering two-dimensional input images, in accordance with some embodiments.

FIG. 4 generally illustrates a vector processor, in accordance with some embodiments.

FIG. 5 generally illustrates the vector processing unit, in accordance with some embodiments.

FIG. 6 generally illustrates a technique for efficiently performing a matrix multiplication of a two-dimensional input matrix arranged in row-major order and a two-dimensional weight matrix arranged in column-major order, in accordance with some embodiments.

FIG. 7 illustrates a workflow for compiling source code into an executable program, in accordance with some embodiments.

FIG. 8 illustrates a flowchart of a method for optimizing a convolution operation on a vector processor, in accordance with some embodiments.

FIG. 9 generally illustrates a detailed view of an exemplary computing device that can be used to implement the various apparatus and/or methods described herein, in accordance with some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

As described, a convolution neural network is a class of deep learning networks that typically includes one or more processors, such as one or more vector processors. Convolutional neural networks include various layers that, using the one or more processors, process inputs (e.g., images or other suitable input) and generate outputs (e.g., class scores, image classifications, or other suitable output). For example, the convolution neural network can include convolution layers that process sets of inputs with convolution kernels to generate sets of outputs. Convolutional layers are typically configured to detect high level features of the inputs, such as edged, curves, simple colors, and the like.

The output of the convolutional layers may be provided by the one or more processors to a fully-connected layer. The fully-connected layer typically connects every neuron in one layer of the convolutional neural network to every other neuron in another layer of the convolutional neural network. The fully-connected layer is configured to receive inputs from the convolutional layers and generate outputs that can be used to predict classifications for images associated with the inputs. For example, during training of the convolutional neural network, a plurality of images may be provided to the convolutional neural network (e.g., using the convolutional layers, as described). The convolutional neural network may learn by using the fully-connected layer to classify each of the images.

Typically, the fully-connected layer receives a two-dimensional input matrix (e.g., from the convolutional layers) arranged in row-major order. The fully-connected layer (e.g., using the one or more processors) uses a two-dimensional weight matrix that comprises a plurality of weight values to classify the input. For example, the one or more processors may perform a dot product operation using the two-dimensional input matrix and the two-dimensional weight matrix. The result of the dot product operation is a two-dimensional output matrix that comprises probability values that indicate a probability that an associated input image is an image of a particular object. The accuracy of the output of the fully-connected layer may be determined and the convolutional neural network may be provided inputs until the accuracy of the fully-connected layer output is above a threshold.

As described, the two-dimensional input matrix is typically arranged in row-major order, such that, a row in the two-dimensional input matrix includes a plurality of associated elements. For example, a first row of elements may be associated with a first batch, and second row of elements may be associated with a second batch, and so on. Depending on a variety of factors, the two-dimensional weight matrix may be arranged in row-major order or column-major order. For example, a hardware structure of memory used in a computing device and/or computing devices on which the convolutional neural network resides and/or which the convolutional neural network uses to process inputs and generate outputs, may dictate whether the two-dimensional weight matrix is arranged in row-major order or column-major order. Additionally, or alternatively, a programming language and/or a programming techniques associated with the convolutional neural network may dictate whether the two-dimensional weight matrix is arranged in row-major order or column-major order.

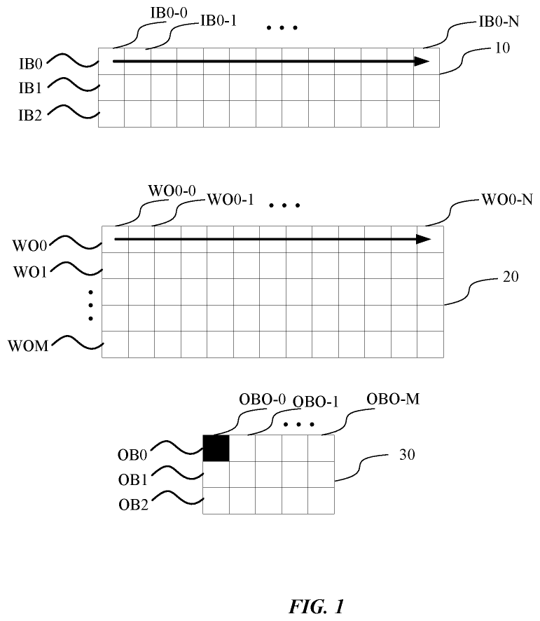

FIG. 1 generally illustrates a two-dimensional input matrix 10 arranged in row-major order and a two-dimensional weight matrix 20 arranged in row-major order, in accordance with some embodiments. The two-dimensional input matrix 10 may include a plurality of input batches, such as batch IB0, batch IB1, and batch IB2. While only three batches are illustrated, it should be understood the two-dimensional input matrix may include any suitable number of batches. Each batch includes a plurality of elements arranged in a corresponding row of the two-dimensional input matrix 10. For example, batch IB0 includes elements IB0-0 to IB0-N. As described, the elements of the two-dimensional input matrix correspond to output elements from a previous layer in the convolutional neural network. For example, the previous layer may include a convolutional layer and the output may include a two-dimensional output matrix (e.g., sometimes referred to as an activation map of high level features detected for the image received by the convolutional neural network).

The two-dimensional weight matrix includes a plurality weight values. The weight values, when applied to the input elements, as will be described, indicate a probability that a batch of elements below to a particular class. For example, a processor, as will be described, performs a series of dot product operations using the two-dimensional input matrix 10 and the two-dimensional weight matrix 20 to generate a two-dimensional output matrix, such as a two-dimensional output matrix 30 that includes a plurality of probability values. A first row OB0 of the two-dimensional output matrix 30 includes probability values that the elements of batch IB0 of the two-dimensional input matrix 10 bellows to particular classes. For example, a first probability value OB0-0 of row OB0 of the two-dimensional output matrix 30 may indicate a probability that the elements associated with batch IB0 of the two-dimensional input matrix 10 belongs to a first class. Each other probability value of the first row OB0 of the two-dimensional output matrix 30 indicates other probabilities that the elements of batch IB0 of the two-dimensional input matrix 10 belongs to other classes.

During training of the convolutional neural network, the weight values may be randomized, which may lead to incorrect probability values (e.g., incorrect classification of input images). As the convolutional neural network learns (e.g., through backpropagation), the weight values are adjusted, which may improve the accuracy of the probability values. This weight adjustment may continue until the accuracy of the probability values is above a threshold (e.g., the convolutional neural network is sufficiently trained to be used by other systems to predict contents of input images).

To perform the matrix multiplication operation of the two-dimensional input matrix 10 (e.g., arranged in row-major order) and the two-dimensional weight matrix 20 (e.g., arranged in column-major order), the processor determines a product between of each element in a row of the two-dimensional input matrix 10 and a corresponding weight value in a row of the two-dimensional weight matrix 20. The processor them sums the products to generate an output probability. The output probability is then stored in the two-dimensional output matrix 30. For example, the processor determines a product between the element IB0-0 in batch IB0 (e.g., the first row) of the two-dimensional input matrix 10 and the weight value WO0-0 in row WO0 of the two-dimensional weight matrix 20.

The processor continues to determine products between elements IB0-1 through IB0-N of batch IB0 of the two-dimensional input matrix 10 and elements WO0-1 through WO0-N of row WO0 of the two-dimensional weight matrix 20. The processor sums the determined products and stores the result as probability OB0-0 in row OB0 of the two-dimensional output matrix 30. The processor then determines products between elements in batch IB0 of the two-dimensional input matrix 10 and weight values in row WO1 of the two-dimensional weight matrix 20 and stores the result of the sum of the determined products as probability OB0-1 of row OB0 of the two-dimensional output matrix 30. The processor continues for to determine products between elements in batch IB0 of the two-dimensional input matrix and each weight value of each row of the two-dimensional weight matrix 20 (e.g., through row WOM of the two-dimensional weight matrix 20) to generate probabilities for row OB0 of the two-dimensional output matrix 30 through probability OB0-M.

The processor then determines products between elements of batch IB1 (e.g., the second row) and batch IB2 (e.g., the third row) of the two-dimensional input matrix 10 and corresponding weight values in each of the rows of the two-dimensional weight matrix 20 to generate probability values stored in row OB1 and row OB2 of the two-dimensional output matrix 30, respectively. As is illustrated, the two-dimensional output matrix 30 includes a number of rows corresponding to a number of rows of the two-dimensional input matrix 10 and a number of columns corresponding to a number of rows of the two-dimensional weight matrix 20.

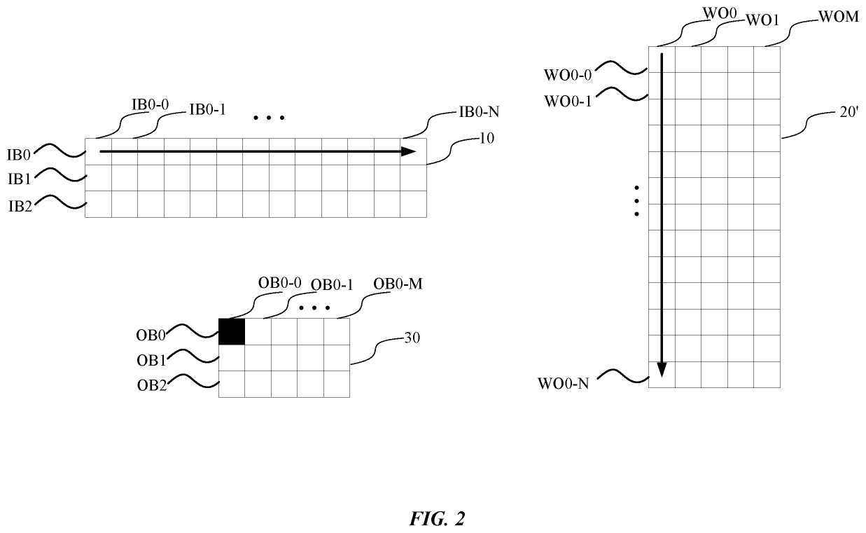

Typically, performing a series of dot product operations using a two-dimensional input matrix arranged in row-major order and a two-dimensional weight matrix arranged in row-major order, is relatively efficient as the processor can perform consecutive memory read operations to retrieve respective input elements and weight values. However, as described, the two-dimensional weight matrix may be arranged in column-major order. FIG. 2 generally illustrates the two-dimensional input matrix 10 arranged in row-major order and a two-dimensional weight matrix 20′ arranged in column-major order, in accordance with some embodiments.

As described, the processor performs a dot product operation using the two-dimensional input matrix 10 and the two-dimensional weight matrix 20′ in order to generate the two-dimensional output matrix 30. The processor determines a product between of each element in a row of the two-dimensional input matrix 10 and a corresponding weight value in a column of the two-dimensional weight matrix 20′. The processor them sums the products to generate an output probability. For example, the processor determines a product between the element IB0-0 in batch IB0 (e.g., the first row) of the two-dimensional input matrix 10 and the weight value WO0-0 in column WO0 of the two-dimensional weight matrix 20′.

The processor continues to determine products between elements IB0-1 through IB0-N of batch IB0 of the two-dimensional input matrix 10 and elements WO0-1 through WO0-N of column WO0 of the two-dimensional weight matrix 20′. The processor sums the determined products and stores the result as probability OB0-0 in row OB0 of the two-dimensional output matrix 30. The processor then determines products between elements in batch IB0 of the two-dimensional input matrix 10 and weight values in column WO1 of the two-dimensional weight matrix 20′ and stores the result of the sum of the determined products as probability OB0-1 of row OB0 of the two-dimensional output matrix 30. The processor continues for to determine products between elements in batch IB0 of the two-dimensional input matrix and each weight value of each column of the two-dimensional weight matrix 20′ (e.g., through column WOM of the two-dimensional weight matrix 20′) to generate probabilities for row OB0 of the two-dimensional output matrix 30 through probability OB0-M.

The processor then determines products between elements of batch IB1 (e.g., the second row) and batch IB2 (e.g., the third row) of the two-dimensional input matrix 10 and corresponding weight values in each of the columns of the two-dimensional weight matrix 20′ to generate probability values stored in row OB1 and row OB2 of the two-dimensional output matrix 30, respectively. As is illustrated, the two-dimensional output matrix 30 includes a number of rows corresponding to a number of rows of the two-dimensional input matrix 10 and a number of columns corresponding to a number of columns of the two-dimensional weight matrix 20′.

Typically, performing a dot product operation using a two-dimensional input matrix arranged in row-major order and a two-dimensional weight matrix arranged in column-major order, can be inefficient as the processor does not perform consecutive memory read operations to retrieve respective input elements and weight values, which may significantly slow training of the convolutional neural network and/or use of the convolutional neural network by other system. Typically, in order to improve efficiency of the dot product operation, the processor may first transpose the two-dimensional weight matrix 20′, such that, the two-dimensional weight matrix 20′ is converted from being arranged in column-major order to being arranged in row-major order. The processor then performs the matrix multiplication operation between the two-dimensional input matrix 10 and the transposed version of the two-dimensional weight matrix 20′ (e.g., arranged in row-major order).

However, such transposition of the two-dimensional weight matrix 20′ can also be relatively resource intensive, and as convolutional neural network training moves from server farms to end user devices (e.g., such as laptop computers, desktop computers, tablet computing devices, and mobile computing devices, such as smart phones), such transposition of the two-dimensional weight matrix 20′ may not be an efficient solution. According, systems and methods, such as those described herein, that increases the efficiency of a matrix multiplication operation between a two-dimensional input matrix arranged in row-major order and a two-dimensional weight matrix arranged in column-major order, may be desirable.

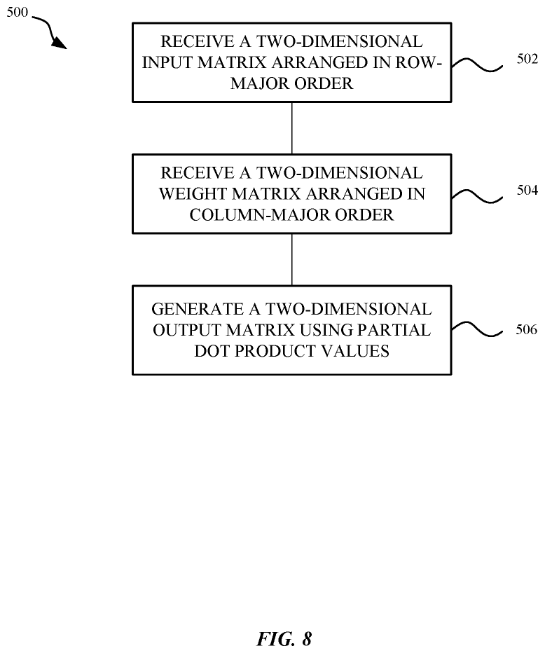

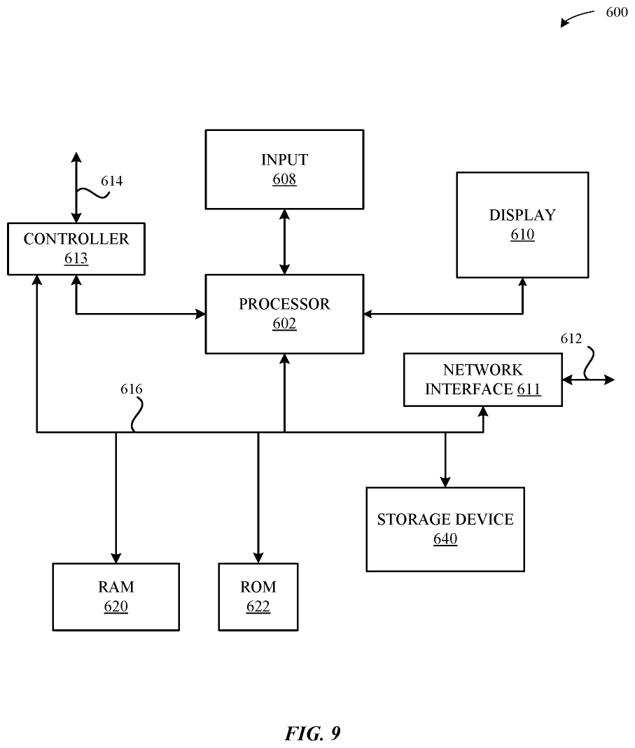

These and other embodiments are discussed below with reference to FIGS. 1-9; however, those skilled in the art will readily appreciate that the detailed description given herein with respect to these figures is for explanatory purposes only and should not be construed as limiting.

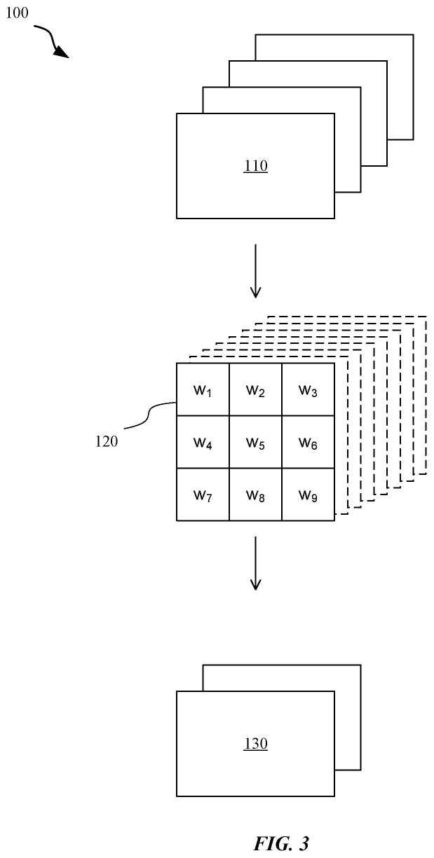

FIG. 3 generally illustrates a multi-layer convolution operation 100 for filtering two-dimensional input images, in accordance with some embodiments. As depicted in FIG. 3, a number of two-dimensional images 110 are received as input to the convolution operation 100. Each image 110 comprises a two-dimensional array of scalar values. Each scalar value in the two-dimensional array can be referred to as an element or, alternatively, a pixel. In some embodiments, each element is a single-precision floating-point value comprising 32-bits. In other embodiments, each element can be represented using another format, such as double-precision floating-point, fixed-point, or integer formats.

Each layer of the multi-layer input can be referred to as a channel of the multi-layer input. In other words, each channel is a separate and distinct image in a set of images provided as the input to the convolution operation 100. In some embodiments, each channel can be a separate color channel of a single color image (e.g., red, green, blue, and alpha channels). In other embodiments, each channel can be a separate and distinct image, each image being unrelated to the other images in the set of images. Such embodiments are particularly suited to deep learning, where a convolution neural network (CNN) can be configured to process a large number of images to produce a result. For example, in a typical implementation of a CNN, the input to the CNN can include 512 separate and distinct images provided as different channels of the input.

The convolution operation 100 generates a number of two-dimensional images 130 as an output of the convolution operation 100. The number of output images 130 may not match the number of input images 110. In other words, the number of channels in the multi-layer output may not be equal to the number of channels in the multi-layer input. However, in some embodiments, the number of channels in the multi-layer output matches the number of channels of the multi-layer input.

Each channel of the output (e.g., each output image 130) is associated with a set of coefficients corresponding to each channel of the input (e.g., each input image 110). Each image 110 is processed by a corresponding convolution kernel 120, which is defined as a set of coefficients applied to a portion of the image 110 to generate a portion of an element of an output of the convolution operation. The intermediate values generated by processing each input image 110 with a corresponding convolution kernel 120 are then summed to produce the element for a particular output image 130. Each output image 130 can be associated with a set of convolution kernels 120, where a number of convolution kernels 120 associated with the output image 130 matches the number of input images 110. For example, as depicted in FIG. 3, each of two output images 130 is associated with four convolution kernels 120 corresponding to the four input images 110, for a total of eight sets of coefficients utilized by the convolution operation 100.

The convolution kernels 120 can be one-dimensional or two-dimensional. Each convolution kernel 120 can be as small as size 1×1, containing only one coefficient. In the one-dimensional case, the convolution kernel 120 can be of size d×1 or 1×d as applied to the rows or columns, respectively, of the image 110. In the two-dimensional case, the convolution kernel 120 can be of size d_{row}×d_{col} as applied to a two-dimensional window of the image 110. For example, common sizes of two-dimensional convolution kernels are 3×3 or 5×5, which include nine or twenty five coefficients, respectively.

As described, the output of the convolutional layers of the CNN (e.g., resulting from the convolutional operation 100 other convolutional operations performed on subsequent layers of the CNN) is provided to the fully-connected layer of the CNN. At the fully-connected layer of the CNN, a dot product operation is performed using a two-dimensional input matrix arranged in row-major order and a two-dimensional weight matrix arranged in column-major order to generate a two-dimensional output matrix that includes a plurality of probability values indicating probabilities that the elements of the images received from the convolutional operation 100 are particular classes of images.

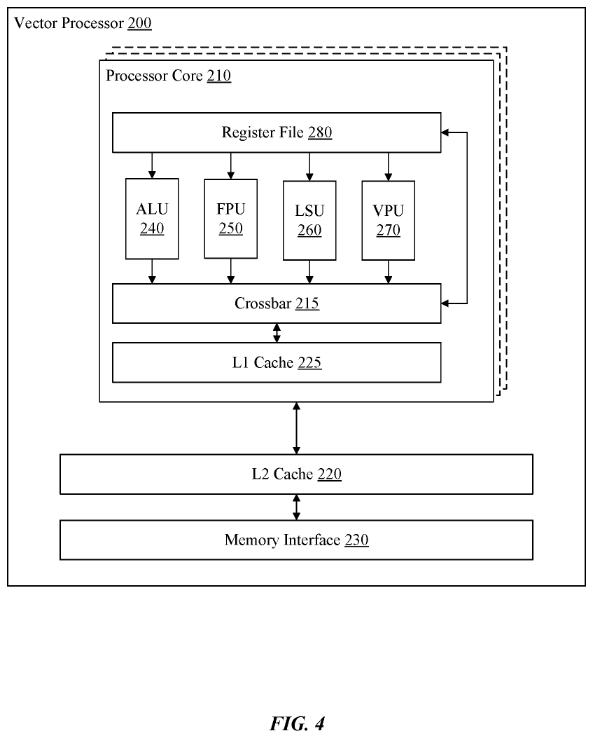

FIG. 4 illustrates a vector processor 200, in accordance with some embodiments. The dot product operation can be implemented on the vector processor 200. In some embodiments, a software library is provided for implementing the dot product operation on the vector processor 200. The software library can include a set of instructions to process dot product operations using various two-dimensional input matrices and various two-dimensional weight matrices. Additionally, or alternatively, the software library may include a set of instructions indicating which two-dimensional weight matrix corresponds to a particular two-dimensional input matrix, which weight values correspond to a particular input image, or a combination thereof.

The vector processor 200 includes one or more processor cores 210. Each processor core 210 maintains architectural state including a number of registers in a register file 280, program counters, interrupt mask registers, instruction flag registers, and/or pipeline registers. The architectural state can be referred to as a processor context. The specific data included in the architectural state can vary depending on the implementation of the processor.

In some embodiments, a processor core 210 can maintain multiple sets of architectural state per processor core 210 to implement simultaneous multi-threading (SMT). For example, a processor core 210 can maintain two program counter registers, two sets of operand registers, two sets of interrupt mask registers, and so forth to implement SMT for two threads. SMT enables the processor core 210 to switch between two or more threads without having to switch the processor context by storing the architectural state for the active thread to a memory and loading architectural state for a different thread from the memory.

As depicted in FIG. 4, the vector processor 200 includes a multi-level memory hierarchy including a level 1 (L1) cache 225 in each processor core 210 and a level 2 (L2) cache 220 shared by multiple processor cores 210. The L2 cache 220 is coupled to a memory interface 230 that is attached to pads of the integrated circuit of the vector processor 200, which are coupled to an external memory device such as a dynamic random access memory (DRAM). Although not shown explicitly, the L1 cache 225 can be divided into an instruction cache and a data cache storing instructions and data, respectively. Additional units of the processor core 210, such as a fetch unit, decode unit, branch prediction unit, and the like, can load instructions for a thread into the instruction cache such that an instruction is ready to be executed when the program counter points to an address for the instruction.

After an instruction has been decoded, control logic for the processor core 210 configures one or more functional units of the processor core 210 to execute the instruction. In some embodiments, the processor core 210 includes an arithmetic logic unit (ALU) 240, a floating-point unit (FPU) 250, a load/store unit (LSU) 260, and a vector processing unit (VPU) 270. The ALU 240 is configured to execute instructions to perform arithmetic operations such as addition, subtraction, multiplication, and division utilizing integer operands. The FPU 250 is configured to execute instructions to perform arithmetic operations such as addition, subtraction, multiplication, and division utilizing floating-point operands. The ALU 240 and FPU 250 operate on scalar values of, typically, 32 or 64 bits. The LSU 260 is configured to execute instructions to load values from external memory into the register file 280 and/or store values from the register file 280 to the external memory. The LSU 260 interacts with the external memory indirectly via the L1 cache 225. The VPU 270 is configured to execute instructions to perform arithmetic operations such as addition, subtraction, multiplication, and division utilizing vector operands. The VPU 270 provides the vector processor 200 with the ability to execute single instruction multiple data (SIMD) instructions.

In some embodiments, the register file 280 includes registers sized to store vector operands. A vector operand refers to an operand having a number of bits that is an integer multiple of a bit width of the data paths implemented by the VPU 270. For example, the VPU 270 can be implemented to include four parallel data paths, configured to operate on single-precision floating-point operands (e.g., 32-bits). A register for a vector operand for such an implementation of the VPU 270 can be sized to hold, e.g., 128 bits, which can store four separate elements of data (e.g., single-precision floating-point values) for the four parallel data paths. Consequently, a single vector instruction can be executed by the VPU 270, which loads vector operands containing four elements from the register file 280 and generates four single-precision values stored in a 128-bit accumulator register in parallel. It will be appreciated that although the VPU 270 has been described as using 128-bit registers containing four elements, other embodiments of the VPU 270 can utilize 256-bit registers containing eight elements, 512-bit registers containing 16 elements, 256-bit registers containing four double-precision floating-point elements, 512-bit registers containing eight double-precision floating-point elements, 128-bit registers containing eight half-precision floating-point elements, and so forth. The number of parallel data paths implemented within the VPU 270 should equal the number of elements stored in the registers for the vector operands.

In some embodiments, the outputs of the functional units are connected to a crossbar 215 or other type of switchable interconnect used to route signals between the functional units, the register file 280, and/or the L1 cache 225. For example, the crossbar 215 can be configured to connect the output of a functional unit, such as the FPU 250 or the VPU 270 to a write port of the register file 280 such that a result generated by the functional unit is written to a particular register, which can then be utilized as an operand for a subsequent instruction executed by the functional unit. As another example, the LSU 260 can provide a value from a register in the register file 280 to the L1 cache 225 to write the value to the external memory.

It will be appreciated that the architecture of the vector processor 200 depicted in FIG. 4 is merely one example of a vector processor 200 and other architectures are contemplated as being within the scope of the present disclosure. For example, each processor core 210 can include two or more VPUs 270 in addition to the other functional units such that multiple vector operations can be performed in parallel. Other components of the processor 200 have been omitted for clarity. For example, clock generation and distribution circuits, scheduling logic, and various buses or interconnects have been omitted to avoid obscuring the description of the embodiments.

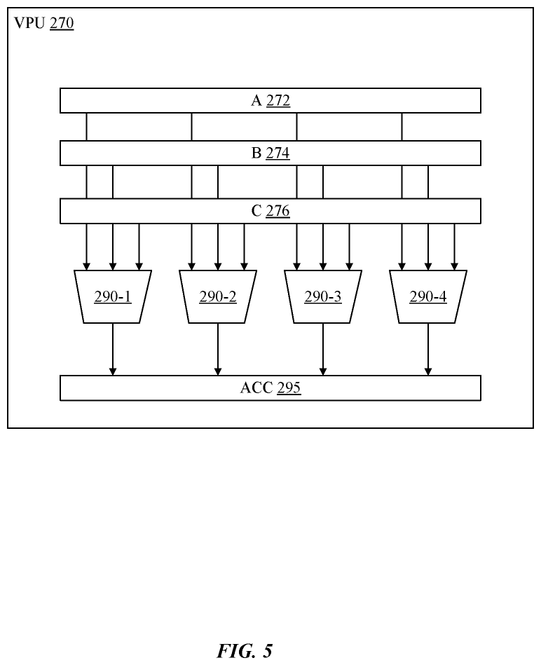

FIG. 5 illustrates the VPU 270, in accordance with some embodiments. The VPU 270 includes a number of data paths 290 operating in parallel. The data paths 290 share access to vector operands stored in special registers in the VPU 270. In some embodiments, the data paths 290 are floating-point data paths configured to execute FMA instructions that have three input operands and one output operand. The input operands are stored in input collectors A 272, B 274, and C 276. Input operands are read from the register file 280 and latched in the corresponding input collector until the instruction is ready to be executed. The vector output, combining the output elements of the data paths 290, is stored in an accumulator 295.

In some embodiments, an FMA instruction causes each data path 290 to read a first element from the input collector A 272 and read a second element from the input collector B 274. The first element is multiplied by the second element to generate a product, which is then added to a third element read from the input collector C 276. The result of the addition of the product and the third element is stored in the accumulator 295. In some embodiments, the VPU 270 can be configured to write the result stored in the accumulator register 295 into the input collector C 276 such that the result can be added to a new product calculated using new operand(s) loaded into at least one of the input collector A 272 or input collector B 274 during a subsequent FMA instruction.

Again, in other embodiments, the VPU 270 can include a different number of data paths 290 operating in parallel and sharing elements from vector operands stored in the input collectors. In yet other embodiments, the data paths 290 can be configured to operate on 16-bit, 64-bit, or 128-bit elements rather than 32-bit elements. In still other embodiments, the VPU 270 can include, in addition to or in lieu of data paths 290, additional data paths and registers configured to operate on integer elements rather than floating-point elements. In some embodiments, the vector processor 200 includes the VPU 270 in lieu of the ALU 240 and the FPU 250.

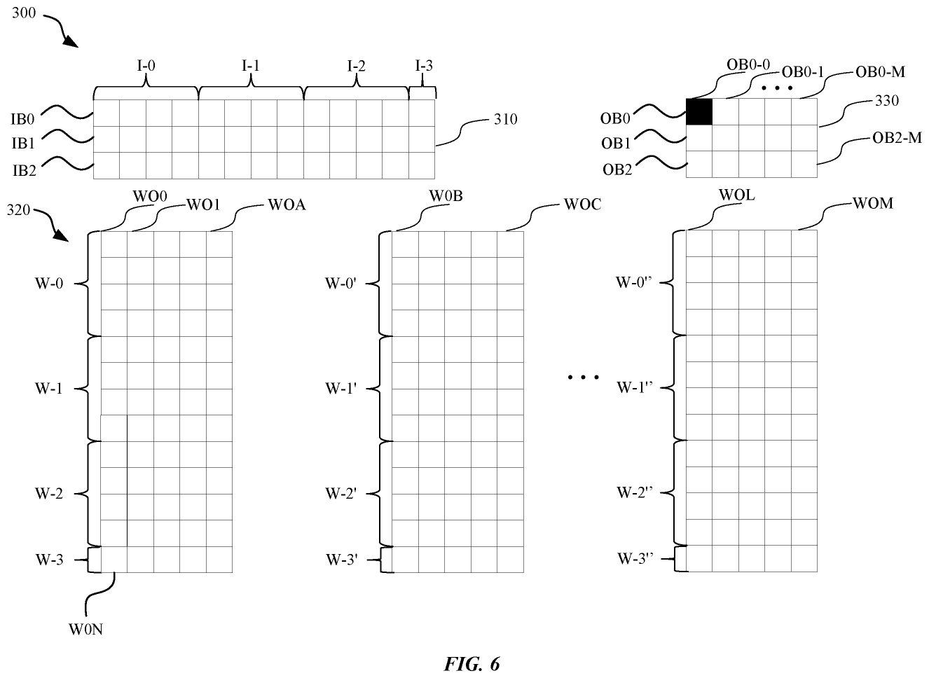

FIG. 6 generally illustrates a technique 300 for efficiently performing a matrix multiplication operation of a two-dimensional input matrix 310 arranged in row-major order and a two-dimensional weight matrix 320 arranged in column-major order, in accordance with some embodiments. As described, the VPU 270 may be configured to perform the set of dot product operations in order to generate a two-dimensional output matrix 330. In some embodiments, the matrix multiplication operation of the two-dimensional input matrix 310 arranged in row-major order and the two-dimensional weight matrix 320 arranged in column-major order can be vectorized.

The two-dimensional input matrix 310 includes a first batch of elements IB0, a second batch of elements IB1, and a third batch of elements IB2. As descried, the two-dimensional input matrix 310 may include any suitable number of batches. The VPU 270 identifies a first block of elements I-0 of the two-dimensional input matrix 310. The first block of elements I-0 includes elements from the first batch of elements IB0, the second batch of elements IB1, and the third batch of elements IB2.

The VPU 270 identifies a first block of weight values W-0 of the two-dimensional weight matrix 320 that corresponds to the first block of elements I-0. For example, a number of columns of the first block of elements I-0 corresponds to a number of rows of the first block of weight values W-0. In some embodiments, the VPU 270 may identify the first block of elements and other blocks of elements of the two-dimensional input matrix 310, as will be described, based on a size of the respective block of elements. For example, the size of the respective block of elements may be selected, such that a corresponding block of weight values fits into a cache level of the VPU 270.

In some embodiments, the VPU 270 loads the first block of elements I-0 to the input collector A 272 and the first block of weight values W-0 to the input collector B 274. In order to improve efficiency of the dot product operations, the VPU 270 determines partial sums of the dot product operation using the first block of elements I-0 and the first block of weight values W-0 to compute partial results of A+1 consecutive outputs in each one of the output batches (OB0-0-OB0-A, OB1-0-OB1-A, OB2-0-OB2-A) of the two dimensional output matrix 330.

The VPU 270 performs the dot product operation using the elements of the first row of the first block of elements I-0 and weight values in the first column of the first block of weight values W-0 associated with subset of the column WO0 of the two-dimensional weight matrix 320. For example, the VPU 270 calculates a product between a first element of the first row of the first block of elements I-0 and a first weight value of in the column WO0 of the first block of weight values W-0. The VPU 270 stores the product in the accumulator 295. The VPU 270 stores a value corresponding the product stored in the accumulator 295 to the input collector C 276. The VPU 270 calculates a product between a second element of the first row of the first block of elements I-0 and a second weight value in the column WO0 of the first block of weight values W-0. The VPU 270 determines a sum between the product and the value stored in the input collector C 276. The VPU 270 stores the sum in the accumulator 295 and stores a value corresponding to the sum stored in the accumulator to the input collector C 276. The VPU 270 continues for all elements in the first row of the first block of elements I-0 and all elements in the column WO0 of the first block of weights W-0. The VPU 270 stores a partial dot product value for the elements of the first row of the first block of elements I-0 and the column WO0 of the first block of weight values W-0, which represent a partial result to element OB0-0.

The VPU 270, in parallel, uses the same block of weight values W-0 and calculates partial dot product values for elements in a second row (e.g., corresponding to the second batch of elements IB1) and the weight values in the first column of W-O to compute another partial results for output OB1-0. The VPU may continue to compute partial dot products by reusing the same weight column with the batch of elements of I-0. For example, the VPU 270 uses, in parallel, the same three batch input lines in I-0 of the two-dimensional input matrix 310 with the second column of W-0 of the two-dimensional weight matrix 320 to compute partial results for OB0-1, OB1-1, OB2-1 of the two-dimensional output matrix 330. The VPU 270 continues to process all W-0 columns of the two-dimensional weight matrix 320 with the same three batch inputs lines in I-0 of the two-dimensional input matrix 310 to compute partial results for elements OB0-0 to OB0-A, OB1-0 to OB1-A, OB2-0 to OB2-A of the two-dimensional output matrix 330.

In some embodiments, instead of continuing down in the two-dimensional weight matrix 320 to process block W-1 with I-1, W-2 with I-2 and W-3 with I-3 to complete the computation of OB0-0 to OB0-A, OB1-0 to OB1-A, OB2-0 to OB2-A, the VPU 270 may continue to the right, reusing the I-0 input block, and may continue to load the weights in all the W-0 variants which result in consecutive memory reads. After completing the W-0 with I-0 computation, the VPU 270 continues to produce partial results for OB0-B-OB0-C, OB1-B-OB1-C, OB2-B-OB2-C of the two-dimensional output matrix 330 by processing block I-0 with block W-0′ of the two-dimensional weight matrix 320. The VPU 270 then continues to process additional W-0 block variants with the block I-0, until the VPU 270 reaches the last W-0 block variant W-0″ with the block I-0. The VPU 270 then produces partial results for all the outputs OB0-0 to OB0-M, OB1-0 to OB1-M and OB2-0 to OB2-M of the two-dimensional output matrix 330.

The VPU 270 then continues by accumulating additional partial results by processing block I-1 of the two-dimensional matrix 310 with block W-1 of the two-dimensional weight matrix 320. The VPU 270 may continue to process block I-1 with W-1′ and all the other W-1 block variants with the block I-1. The VPU 270 may complete W-1 block variants computations with block I-1. The VPU 270 continues in the same manner to accumulate partial dot product results of all W-2 block variants with 1-2 block and finally all W-3 block variants with I-3 input block. When the VPU 270 completes all W-3 block variants with I-3 input block computations, all of the output computations OB0-0 to OB0-M, OB1-0 to OB1-M and OB2-0 to OB2-M are complete and the two-dimensional output matrix 330 is complete.

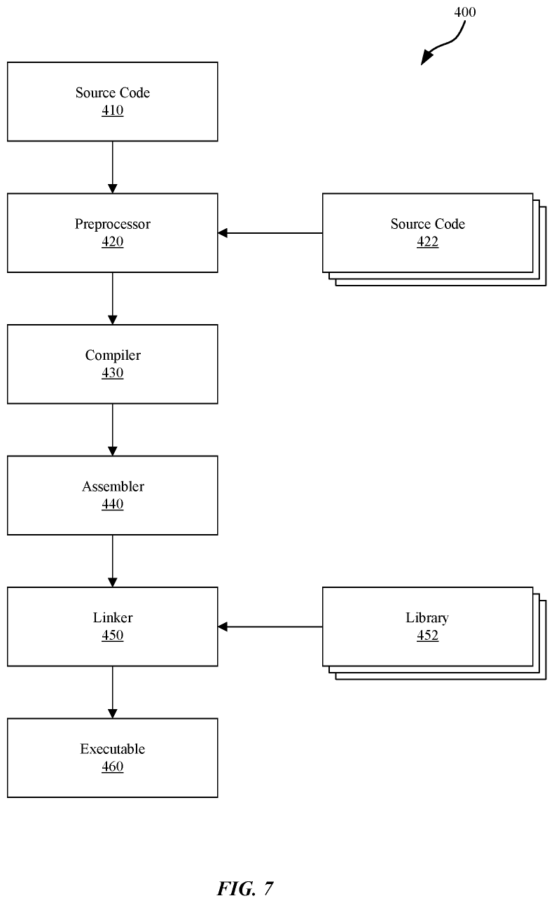

FIG. 7 illustrates a workflow 400 for compiling source code into an executable program, in accordance with some embodiments. As shown in FIG. 7, a software developer generates source code 410 for an application. The source code 410 can be written in a variety of programming languages. The first step in compiling the source code 410 is performed by a program called a preprocessor 420. The preprocessor 420 parses the source code 410 and expands preprocessor directives such as macros, conditional compiler statements, and include statements. In some cases, the preprocessor 420 can replace a preprocessor directive included in the source code 410 with additional source code 422 in one or more separate files.

The pre-processed source code is then processed by the compiler 430, which converts the source code from a high-level language to an assembly language. The converted source code is then processed by the assembler 440, which converts the source code from the assembly language to machine code, which can be referred to as an object file. Finally, the object file is processed by the linker 450, which links the object file with libraries 452 (e.g., additional pre-compiled object files) to produce an executable program 460.

It will be appreciated that the techniques described above for performing a dot product operation can be implemented in multiple ways. For example, referring to various parts of FIG. 7, the source code 410 can include high-level program code that, when compiled into the executable program 460 and executed by the vector processor 200, causes the vector processor 200 to identify the blocks of elements of the two-dimensional input matrix 310, identify the blocks of weight values of the two-dimensional weight matrix 320, calculate the partial dot products, and calculate the dot products using the partial dot products, as described.

In some embodiments, the high-level program code can be generated by a first software developer and provided to a second software developer as a software framework within one or more of the additional source code 422 files. The second software developer can then utilize the functions included in the software framework to include similar functionality related to performing dot product operations as described in more detail above. For example, the software framework could provide constructors and methods for implementing a dot product operating for a fully-connected layer having a two-dimensional weight matrix arranged in column-major order.

In yet other embodiments, a software developer can develop libraries 452 that are compiled into object code and linked with the object code generated by the assembler 440 during compilation of the executable program 460. The software developer can specify an application programming interface (API) that is utilized within the source code 410 to call functions implemented by the libraries 452. For example, a library could be specified that calculates the partial dot products for the two-dimensional input matrix 310 and the two-dimensional weight matrix 320, as described. Such embodiments are different from the software framework described above in that the libraries are compiled into binary object files, and source code for the functions in the libraries are typically not provided to the software developer to modify or extend.

In still other embodiments, such functionality can be built-in to an operating system that provides an execution environment for the executable program 460. For example, performing a dot product operating using the partial dot product values, as described, can be a standard operation made available to executable program 460 by the operating system by way of a system call.

FIG. 5 illustrates a flowchart of a method 500 for optimizing a dot product operation on a vector processor, in accordance with some embodiments. The method 500 can be performed by software, hardware, or any combination of software or hardware. In some embodiments, the method 500 is implemented by a plurality of instructions executed by the vector processor 200 included in a computing device.

At 502, a computing device including a vector processor receives a two-dimensional input matrix arranged in row-major order, such as the two-dimensional input matrix 310, as described. At 504, the computing device receives a two-dimensional weight matrix arranged in column-major order, such as the two-dimensional weight matrix 320, as described.

At 506, the computing device generates a two-dimensional output matrix, such as the two-dimensional output matrix 330, as described, using partial dot product values. For example, as described, the computing device identifies blocks of elements in the two-dimensional input matrix 310 and blocks of weight values in the two-dimensional weight matrix 320 that correspond to the blocks of elements. The computing device determines partial dot products for each row of each respective block of elements using each column of each respective block of weight values. The computing device sums corresponding partial dot product values to generate probability values of the two-dimensional output matrix 330.

FIG. 10 illustrates a detailed view of an exemplary computing device 600 that can be used to implement the various apparatus and/or methods described herein, in accordance with some embodiments. In particular, the detailed view illustrates various components that can be included in the computing devices described herein.

As shown in FIG. 10, the computing device 600 includes a processor 602 that represents a microprocessor or controller for controlling the overall operation of computing device 600. In some embodiments, the processor 602 is a vector processor 200. Alternatively, the processor 602 can communicate with the vector processor 200 to execute the dot product operation. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of sensor data, etc. Still further, the computing device 600 can include a display 610 (screen display) that can be controlled by the processor 602 to present visual information to the user. A data bus 616 can facilitate data transfer between at least a storage device 640, the processor 602, and a controller 613. The controller 613 can be used to interface with and control different equipment through an equipment control bus 614. The computing device 600 can also include a network/bus interface 611 that couples to a data link 612. In the case of a wireless connection, the network/bus interface 611 can include a wireless transceiver.

In some embodiments, the processor 602 can be embodied in a variety of forms. For example, the processor 602 can be embodied as various processing hardware-based means such as a microprocessor, a coprocessor, a controller or various other computing or processing devices including integrated circuits such as, for example, an application specific integrated circuit (ASIC), a field programmable gate array (FPGA), some combination thereof, or the like. Although illustrated as a single processor, it will be appreciated that the processor 602 can include two or more processors. The processors can be in operative communication with each other and can be collectively configured to perform one or more functionalities of the computing device 600 as described herein. In some embodiments, the processor 602 can be configured to execute instructions that can be stored in the RAM 620 or that can be otherwise accessible to the processor 602.

The computing device 600 also include a storage device 640, which can comprise a single disk or a plurality of disks (e.g., hard drives), and includes a storage management module that manages one or more partitions within the storage device 640. In some embodiments, storage device 640 can include flash memory, semiconductor (solid state) memory or the like. The computing device 600 can also include a Random-Access Memory (RAM) 620 and a Read-Only Memory (ROM) 622. The ROM 622 can store programs, utilities, or processes to be executed in a non-volatile manner. The RAM 620 can provide volatile data storage, and stores instructions related to the operation of the computing device 600.

In some embodiments, a method for classifying information using a fully-connected layer of a convolutional neural network includes, at a computing device, receiving a two-dimensional input matrix that includes a plurality of elements, wherein each row of the two-dimensional input matrix corresponds to a batch of elements. The method further includes identifying a two-dimensional weight matrix corresponding to the two-dimensional input matrix, the two-dimensional weight matrix including a plurality of weight values. The method further includes identifying a first block of elements of the two-dimensional input matrix. The method further includes loading a first weight block of the two-dimensional weight matrix. The method further includes calculating a first partial output for the first block of elements by performing a first dot product operation using a first row of elements of the first block of elements and the first weight block, wherein the first row of elements of the first block of elements corresponds to a first batch of elements. The method further includes storing the first partial output. The method further includes generating a first output element using the first partial output for the first block of elements and at least one other partial output corresponding to the first batch of elements.

In some embodiments, a number of rows in the first weight block corresponds to a number of columns in the first block of elements. In some embodiments, the two-dimensional weight matrix is arranged in column-major order. In some embodiments, the method is implemented by at least one processor of the computing device, and the at least one processor includes a vector processing unit. In some embodiments, the method also includes, in response to storing the first partial output for the first block of elements, reloading the first weight block. In some embodiments, the method also includes calculating a second partial output for the first block of elements by performing a second dot product operation using a second row of elements of the first block of elements and the first weight block, wherein the second row of elements of the first block of elements corresponds to a second batch of elements. In some embodiments, the method further includes generating a second output element using the second partial output for the first block of elements and at least one other partial output corresponding to the second batch of elements. In some embodiments, the method further includes identifying a second block of elements of the two-dimensional input matrix. In some embodiments, the method further includes loading a second weight block of the two-dimensional weight matrix. In some embodiments, the method further includes calculating a first partial output for the second block of elements by performing a third dot product operation using a first row of elements of the second block of elements and the second weight block, wherein the first row of elements of the second block of elements corresponds to a first batch of elements.

In some embodiments, at least one non-transitory computer readable medium storing instructions that, when executed by at least one processor included in a computing device, cause the computing device to perform steps that include: receiving a two-dimensional input matrix that includes a plurality of elements, wherein each row of the two-dimensional input matrix corresponds to a batch of elements; identifying a two-dimensional weight matrix corresponding to the two-dimensional input matrix, the two-dimensional weight matrix including a plurality of weight values; identifying a first block of elements of the two-dimensional input matrix; loading a first weight block of the two-dimensional weight matrix; calculating a first partial output for the first block of elements by performing a dot product operation using a first row of elements of the first block of elements and the first weight block, wherein the first row of elements of the first block of elements corresponds to a first batch of elements; storing the first partial output; and generating a first output element using the first partial output for the first block of elements and at least one other partial output corresponding to the first batch of elements.

In some embodiments, a number of rows in the first weight block corresponds to a number of columns in the first block of elements. In some embodiments, the two-dimensional weight matrix is arranged in column-major order. In some embodiments, the at least one processor includes a vector processing unit. In some embodiments, wherein the steps further include, in response to storing the first partial output for the first block of elements, reloading the first weight block. In some embodiments, wherein the steps further include calculating a second partial output for the first block of elements by performing a dot product operation using a second row of elements of the first block of elements and the first weight block, wherein the second row of elements of the first block of elements corresponds to a second batch of elements. In some embodiments, wherein the steps further include generating a second output element using the second partial output for the first block of elements and at least one other partial output corresponding to the second batch of elements. In some embodiments, the steps further comprise: identifying a second block of elements of the two-dimensional input matrix loading a second weight block of the two-dimensional weight matrix; calculating a first partial output for the second block of elements by performing a dot product operation using a first row of elements of the second block of elements and the second weight block, wherein the first row of elements of the second block of elements corresponds to a first batch of elements.

In some embodiments, a computing device configured to classify information using a fully-connected layer of a convolutional neural network includes at least one memory and a vector processor coupled to the at least one memory. The at least one memory stores: a two-dimensional input matrix that includes a plurality of elements, wherein each row of the two-dimensional input matrix corresponds to a batch of elements; and a two-dimensional weight matrix corresponding to the two-dimensional input matrix, the two-dimensional weight matrix including a plurality of weight values. The vector processor is configured to cause the computing device to: identify a first block of elements of the two-dimensional input matrix; load a first weight block of the two-dimensional weight matrix; calculate a first partial output for the first block of elements by performing a dot product operation using a first row of elements of the first block of elements and the first weight block, wherein the first row of elements of the first block of elements corresponds to a first batch of elements; store the first partial output; and generate a first output element using the first partial output for the first block of elements and at least one other partial output corresponding to the first batch of elements.

In some embodiments, a number of rows in the first weight block corresponds to a number of columns in the first block of elements. In some embodiments, the two-dimensional weight matrix is arranged in column-major order. In some embodiments, the vector processor is further configured to cause the computing device to, in response to storing the first partial output for the first block of elements, reload the first weight block.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for classifying information using a fully-connected layer of a convolutional neural network, the method comprising, at a computing device:
receiving a two-dimensional input matrix that includes a plurality of elements, wherein each row of the two-dimensional input matrix corresponds to a batch of elements;
identifying a two-dimensional weight matrix corresponding to the two-dimensional input matrix, the two-dimensional weight matrix including a plurality of weight values;
identifying a first block of elements of the two-dimensional input matrix;
loading a first weight block of the two-dimensional weight matrix;
calculating a first partial output for the first block of elements by performing a first dot product operation using a first row of elements of the first block of elements and the first weight block, wherein the first row of elements of the first block of elements corresponds to a first batch of elements;
storing the first partial output; and
generating a first output element using the first partial output for the first block of elements and at least one other partial output corresponding to the first batch of elements.

2. The method of claim 1, wherein a number of rows in the first weight block corresponds to a number of columns in the first block of elements.

3. The method of claim 1, wherein the two-dimensional weight matrix is arranged in column-major order.

4. The method of claim 1, wherein the method is implemented by at least one processor of the computing device, and the at least one processor includes a vector processing unit.

5. The method of claim 1, further comprising, in response to storing the first partial output for the first block of elements:
reloading the first weight block.

6. The method of claim 5, further comprising:
calculating a second partial output for the first block of elements by performing a second dot product operation using a second row of elements of the first block of elements and the first weight block, wherein the second row of elements of the first block of elements corresponds to a second batch of elements.

7. The method of claim 6, further comprising:
generating a second output element using the second partial output for the first block of elements and at least one other partial output corresponding to the second batch of elements.

8. The method of claim 1, further comprising:
identifying a second block of elements of the two-dimensional input matrix;
loading a second weight block of the two-dimensional weight matrix; and
calculating a first partial output for the second block of elements by performing a third dot product operation using a first row of elements of the second block of elements and the second weight block, wherein the first row of elements of the second block of elements corresponds to a first batch of elements.

9. At least one non-transitory computer readable medium storing instructions that, when executed by at least one processor included in a computing device, cause the computing device to perform steps that include:
receiving a two-dimensional input matrix that includes a plurality of elements, wherein each row of the two-dimensional input matrix corresponds to a batch of elements;
identifying a two-dimensional weight matrix corresponding to the two-dimensional input matrix, the two-dimensional weight matrix including a plurality of weight values;
identifying a first block of elements of the two-dimensional input matrix;
loading a first weight block of the two-dimensional weight matrix;
calculating a first partial output for the first block of elements by performing a first dot product operation using a first row of elements of the first block of elements and the first weight block, wherein the first row of elements of the first block of elements corresponds to a first batch of elements;
storing the first partial output; and
generating a first output element using the first partial output for the first block of elements and at least one other partial output corresponding to the first batch of elements.

10. The at least one non-transitory computer readable medium of claim 9, wherein a number of rows in the first weight block corresponds to a number of columns in the first block of elements.

11. The at least one non-transitory computer readable medium of claim 9, wherein the two-dimensional weight matrix is arranged in column-major order.

12. The at least one non-transitory computer readable medium of claim 9, wherein the at least one processor includes a vector processing unit.

13. The at least one non-transitory computer readable medium of claim 9, wherein the steps further include, in response to storing the first partial output for the first block of elements:
reloading the first weight block.

14. The at least one non-transitory computer readable medium of claim 13, wherein the steps further include:
calculating a second partial output for the first block of elements by performing a second dot product operation using a second row of elements of the first block of elements and the first weight block, wherein the second row of elements of the first block of elements corresponds to a second batch of elements.

15. The at least one non-transitory computer readable medium of claim 14, wherein the steps further include:
generating a second output element using the second partial output for the first block of elements and at least one other partial output corresponding to the second batch of elements.

16. The at least one non-transitory computer readable medium of claim 9, wherein the steps further include:
identifying a second block of elements of the two-dimensional input matrix; and
loading a second weight block of the two-dimensional weight matrix;
calculating a first partial output for the second block of elements by performing a third dot product operation using a first row of elements of the second block of elements and the second weight block, wherein the first row of elements of the second block of elements corresponds to a first batch of elements.

17. A computing device configured to classify information using a fully-connected layer of a convolutional neural network, the computing device comprising:
at least one a memory, storing:
a two-dimensional input matrix that includes a plurality of elements, wherein each row of the two-dimensional input matrix corresponds to a batch of elements, and
a two-dimensional weight matrix corresponding to the two-dimensional input matrix, the two-dimensional weight matrix including a plurality of weight values, and
a vector processor coupled to the at least one memory and configured to cause the computing device to:
identify a first block of elements of the two-dimensional input matrix,
load a first weight block of the two-dimensional weight matrix,
calculate a first partial output for the first block of elements by performing a dot product operation using a first row of elements of the first block of elements and the first weight block, wherein the first row of elements of the first block of elements corresponds to a first batch of elements,
store the first partial output, and
generate a first output element using the first partial output for the first block of elements and at least one other partial output corresponding to the first batch of elements.

18. The computing device of claim 17, wherein a number of rows in the first weight block corresponds to a number of columns in the first block of elements.

19. The computing device of claim 18, wherein the two-dimensional weight matrix is arranged in column-major order.

20. The computing device of claim 17, wherein the vector processor is further configured to cause the computing device to, in response to storing the first partial output for the first block of elements:
reload the first weight block.
